(19) United States
(12) Patent Application Publication
(10) Pub. No.: US 2008/0115367 A1
(43) Pub. Date: May 22, 2008

(54) REMOVEABLE ATTACHMENT FOR A POWERED TOOL

(76) Inventor: James P. Glynn, Maryland Heights, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/941,765

(22) Filed: Nov. 16, 2007

Related U.S. Application Data
(63) Continuation-in-part of application No. 10/585,683.
(60) Provisional application No. 60/859,392, filed on Nov. 16, 2006.
(60) Provisional application No. 60/535,292, filed on Jan. 9, 2004.
(60) Provisional application No. 60/558,170, filed on Mar. 31, 2004.

(51) Int. Cl. B23D 51/10

(52) U.S. Cl. 30/122; 30/509

(57) ABSTRACT

A removeable attachment for a powered tool includes a frame with a continuous loop blade positioned in a coplanar relationship with the frame along a system of blade guides so that a cutting surface of the blade faces a desired cutting area. The relative positions between the frame arms, the frame handle, and the blade provides a degree of stability and control that allows the operator to precisely and accurately control the cutting surface of the blade along curves, notches, and protrusions, including those involved in coping and sanding. In addition, this arrangement results in a compact design that positions the cutting surface in close proximity to the handle.

### CROSS-REFERENCE TO RELATED APPLICATIONS

This application is related to U.S. Provisional Patent Application No. 60/859,392 filed Nov. 16, 2007 from which priority is claimed, and is hereby incorporated by reference, and is a continuation-in-part of U.S. patent application Ser. No. 10/585,683 filed Jul. 10, 2006 from which priority is claimed, and which is hereby incorporated by reference, which is a national phase application of International Application No. PCT/US2005/00146 filed Jan. 5, 2005, which priority is claimed, and which is hereby incorporated by reference, which claims priority to U.S. Provisional Patent Application No. 60/535,292 filed Jan. 9, 2004, and U.S. Provisional Patent Application No. 60/558,170 filed Mar. 31, 2004, the disclosures of which are hereby incorporated by reference.

### STATEMENT REGARDING FEDERALLY SPONSORED RESEARCH

Not Applicable.

### BACKGROUND OF THE INVENTION

This invention relates generally to hand-held cutting and sanding power tools.

While the invention is described in particular detail with respect to an attachment for a particular type of saw known as a “coping saw,” those skilled in the art will recognize the wider applicability of the inventive principles disclosed hereinafter.

Hand-held saws are well known in the art being primarily used in cutting and fitting molding pieces together in the corner junction of a room, referred to as “coping.” The purpose of coping is to make two pieces of molding match up at a corner without a seam, giving an aesthetic pleasing appearance of a continuous border of molding. To accomplish this, the hand-held saw must make a precise cut along one end of a piece

Typically, hand-held saws use a narrow blade that is held under tension within a U-shaped frame. However, using hand-held saws is a slow labor-intensive process. In addition, a hand-held saw dedicated to one task, such as a coping saw, can not be used to accomplish other tasks, for example, sanding or cutting of other materials, including pipes, cables, beams, or other such tasks and/or materials. Attempts have been made to develop powered hand-held saws, but none of these attempts have provided a powered hand-held saw that is both efficient and ergonomic while still providing precise control of the saw. In addition, none of these attempts have provided an attachment that can be used with other power tools for multiple applications.

Consequently, there is a need for a powered hand-held saw attachment that is efficient, ergonomic, and provides precise control of multiple tasks.

### DESCRIPTION OF THE DRAWINGS

In the accompanying drawings which form part of the specification:

FIG. 1 is a plan view of a first embodiment of the invention;

FIG. 2 is a partial end view of the first embodiment of the invention;

FIG. 3 is a left-side view of the first embodiment of the invention;

FIG. 4 is a plan view of a second embodiment of the invention;

FIG. 5 is a partial end view of the second embodiment of the invention;

FIG. 6 is a plan view of a third embodiment of the invention;

FIG. 7 is a partial end view of the third embodiment of the invention;

FIG. 8 is a plan view of a fourth embodiment of the invention; and

FIG. 9 is a partial end view of the fourth embodiment of the invention.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

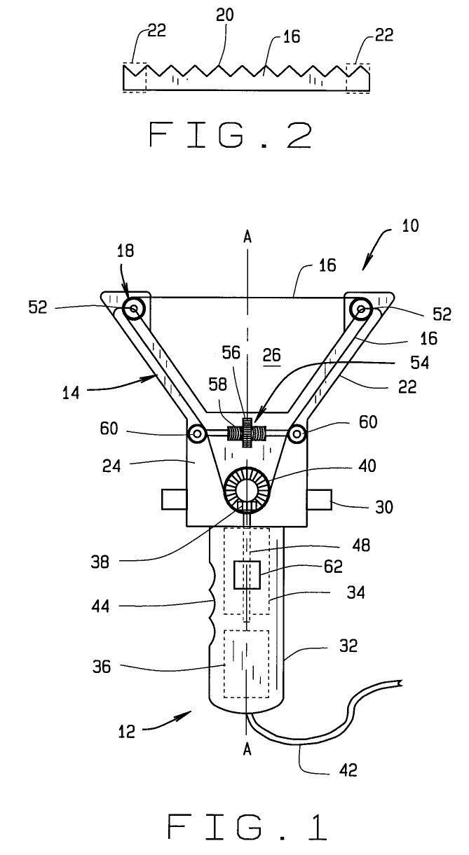

As shown in FIGS. 1-3, an embodiment of the present invention, generally referred to as a power tool attachment 10 for removeable engagement with a powered tool 12, includes a generally V-shaped frame 14 with a continuous loop or blade 16 positioned in a coplanar relationship with the frame 14 along a system of guides 18 so that a cutting surface 20 of the blade 16 faces a desired cutting area. In the present embodiment, the blade 16 is a band saw blade. However, those skilled in the art will recognize that any type of blade, band, belt and/or replacement blade, band, or belt may be used for cutting or sanding, including, for example, an abrasive cable, abrasive belt, wire blade, spiral blade, or cylinder blade, the terms blade, band, and belt used in their generic sense as the cutting or sanding portion of the attachment 10. The ability to use multiple types of blades, bands, or belts provides the attachment 10 with the capability to cut or sand multiple types of materials, including, but not limited to wood, metal, plastic, pipes, cables, and beams.

The frame 14 includes two arms 22 extending axially outwardly from an engagement end 24 to form, in the embodiment illustrated, a generally V-shape, the V-shape defining an opening or throat 26. As will be appreciated by those skilled in the art, other shapes may be employed, if desired. The engagement end 24 a generally U-shaped defining a channel 28 that removeably engages with a powered tool 12 using fasteners 30. However, other means of at removeable engagement can be substituted, such as clamp, hook, adhesive, tape, binding, or latch, which are intended as examples and not as limitations of other methods and structures.

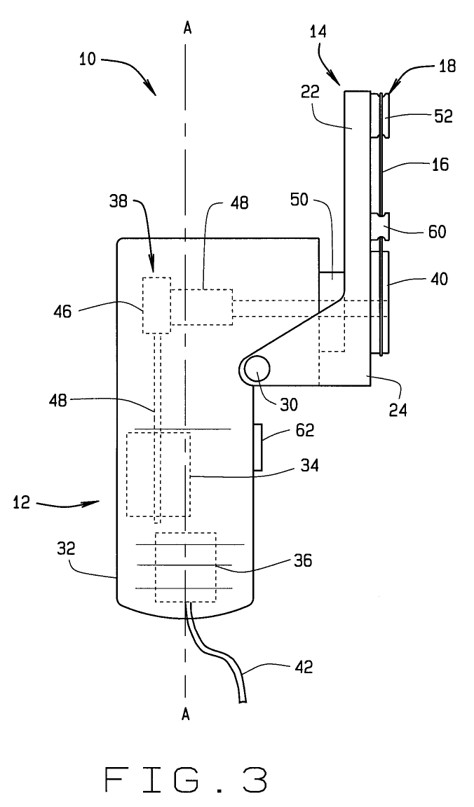

As shown in FIG. 3, the powered tool 12 includes a handle 32 that houses a motor 34, which is operatively connected between a suitable power supply 36, and a gear system 38. The gear system 38 in turn operatively connects the motor 34 to a driven guide 40 for transferring power to the blade 16. Various gear arrangements are compatible with the broader aspects of the invention. In this embodiment, the motor 34 is a variable speed electric motor that is electrically connected to the power supply 36, which comprises an electrical cord 42 that plugs into a standard 120V outlet. However, those skilled in the art will recognize that any suitable means of power supply may be used to power the motor 34 including by way of example and not of limitation, batteries, fuel cells, hydraulics, or air. Other embodiments may include a motor 34 that oscillates the blade 16 back and forth, instead of rotating the blade 16 around in a loop. For comfort and ease of use and control, handle 32 is ergonomically designed and includes notches 44 for fingers. Of course, the notches 44 may be located on any side of the handle 32 to accommodate the fingers of left-handed as well as right-handed operators.

The gear system 38 includes a bevel drive gear 46 attached to a drive shaft 48 of the motor 34. The drive gear 46 couples with a driven gear 48, which is also housed within the handle 32, to transfer power in a right-angle to a chuck 50. The chuck 50 engages a driven guide 40 and, thus, drives the blade 16 around the system of guides 18. The gear system 38 may comprise any arrangement of gears that can transfer power from the motor 34 to the chuck 50, including, for example, hypoid gears, miter gears, helical gears, worm gears, pinion gears or straight gears. The gear system 38 may also comprise gear configurations other than the embodiments shown in FIG. 1 and 3, such as having additional gears that increase or decrease the torque and speed from the motor 34 to the blade 16, such as reduction gears. In an alternate embodiment (not shown), the gear system 38 has multiple gears that allow the operator to select from multiple speeds and torques similar to a transmission. In addition, the gear system 38 can be configured to transfer power in a linear, angled, or other direction.

The system of guides 18 include guides 52, such as pulleys or roller bearings, mounted at the end of each arm 22 of the frame 14, which provide minimal friction while maintaining the position of the blade 16. The driven guide 40 is mounted at the engagement end 24 of the frame 14. The blade 16 is rotationally mounted in a loop around the guides 52 and the driven guide 40.

Preferably, tension on the blade 16 is maintained and adjusted using a tension device 54 mounted between the arms 22. The tension device 54 includes an adjustment nut 56 and an adjustment screw 58 operatively connected to tension rollers 60, such as pulleys or roller bearings. The tension rollers 60 are adjustably mounted within slots on the arms 22 so that they slide toward and away from the blade 16, thereby, adjusting the tension on the blade 16. Rotating the adjustment nut 56 along the adjustment screw 58 increases or decreases the distance between the tension rollers 60 toward and away from the blade 16. Decreasing the distance between the tension rollers 60 increases the tension of the blade 16, while increasing the distance between the tension rollers 60 decreases the tension on the blade 16. The adjustment of the tension device 54 allows the operator to adjust the blade 16 to match a particular coping cut. The tension device 54 also permits easy blade 16 replaced by removing tension on the blade 16 allowing blade 16 removal from the guides 52 and driven guide 40 and the installation of a replacement blade. Those skilled in the art will recognize that other types of tension devices may be used to maintain tension on the blade 16, including, but limited to biasing elements (i.e. springs) operatively connected between the arms 22 or rollers 60, gas or hydraulic cylinder operatively connected between the arms 22 or rollers 60, or a ratchet assembly operatively connected between the arms 22 or rollers 60.

When the attachment 10 is engaged with the powered tool 12, the relative positions between the arms 22, the handle 32, and the blade 16 allow the cutting surface 32 of the blade 16, which extends between the guides 52, to operate in a direction that is normal to the longitudinal axis A-A of the handle 2. In addition, this arrangement results in a compact design that positions the cutting surface 20 in close proximity to the handle 32. As a result, this arrangement provides a degree of stability and control of the attachment 10 that allows the operator to precisely and accurately control the cutting surface 20 along curves, notches, and protrusions, including those involved in coping and sanding. In addition, this arrangement provides an operator an unrestricted view of the cut being made during operation, which is one of a number of distinguishing features of the invention from prior art. Another advantage of the attachment of the present invention is that generally flush cuts can be made in a work piece, for example, when the attachment 10 is positioned perpendicularly to the work piece.

Handle 32 also includes a switch 62 operatively connected to the motor 34, which the operator engages to turn the motor 34 on and off, control the speed, or reverse the direction of the motor 34. In this embodiment, switch 62 is a trigger type momentary switch positioned adjacent the notches 44 for engagement by a finger. However, other types of switches may be used, such as a pushbutton switch. In addition, the switch 62 may be positioned in other locations for engagement by other methods, such as by a thumb.

For safety of operation, the attachment 10 may includes a cover (not shown) that surrounds the tension device 54 and gear system 38. Also, guards (not shown) may be mounted to the ends of the arms 22 to protect the operator from the blade 16. The arms 22 themselves act as guards to protect the operator from the blade 16. If necessary an additional guard (not shown), may be placed along the cutting area of the blade.

In operation, the operator grips the handle 32 and engages the switch 62 to turn on the motor 34 of the powered tool 12. The motor 34 transfers power through the gear system 38 to the driven guide 40 to drive the blade 16 around the guides 52. If necessary, the operator adjusts the tension on the blade 16 by adjusting the tension device 54. Once the motor 34 is turned on, the operator guides the attachment 10 and cutting surface 20 precisely and accurately along a desired cutting path including any curves, notches, and protrusions.

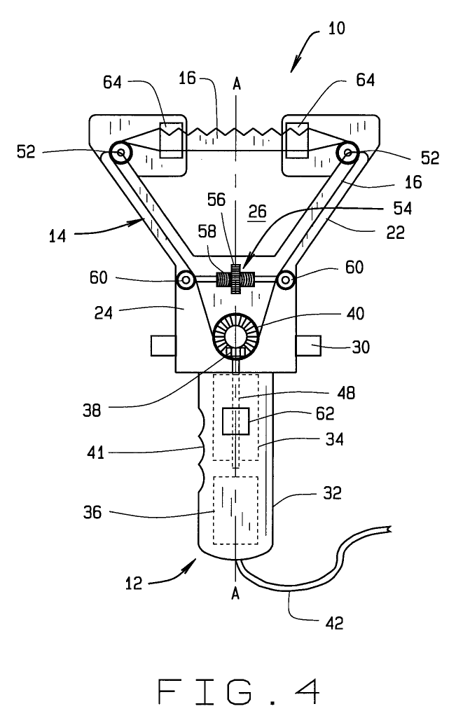

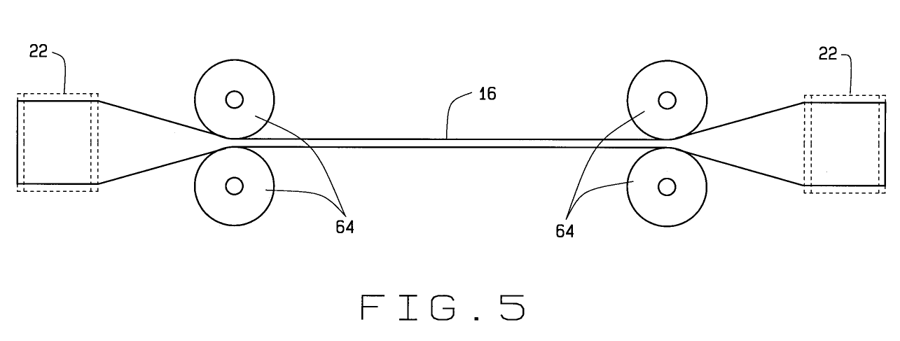

The present invention can also be embodied in the form of the attachment 10 shown in FIGS. 4-5. In this embodiment, the attachment 10 includes bending rollers 64 mounted to the arms 22 for changing the plane of cutting surface 20. The bending rollers 64 are positioned at each end of the cutting surface 20 parallel with the longitudinal axis A-A of the handle 32. In this way, the bending rollers 64 rotate the angle of the cutting surface 20 relative to the rest of the blade 16. As shown in FIGS. 4-5, the cutting surface 16 is rotated 90° relative to the rest of the blade. However, the bending rollers 64 may be adjusted to rotate the cutting surface 20 more or less than 90°.

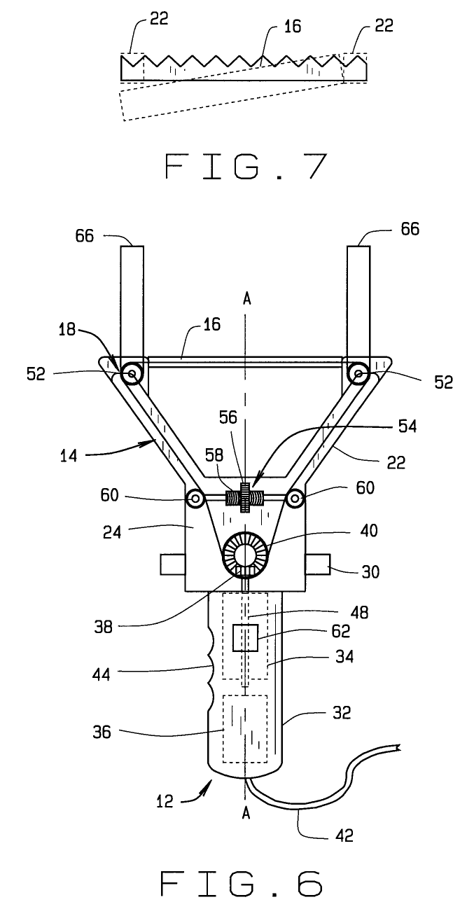

The device of the present invention can also be embodied in the form of the attachment 10 shown in FIG. 6. In this embodiment, arms 22 are pivotally mounted to the engagement end 24 of the frame 12 so that the cutting surface 20 may be rotated about the longitudinal axis A-A of the handle 32. This allows the operator to adjust the angle of the cutting surface 20 relative to the longitudinal axis A-A of the handle 32.

Also included in this embodiment are material guides 66 that are pivotally attached to the guides 54. The material guides 66 may be pivoted about the guides 54 from an open and closed position.

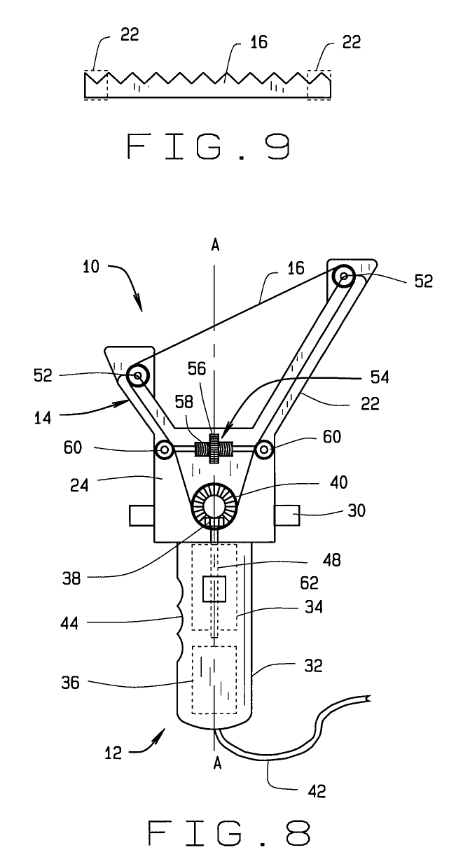

The device of the present invention can also be embodied in the form of the attachment 10, as shown in FIG. 8. In this embodiment, arms 22 may be adjusted in length so that the angle of the cutting surface 20 relative to the longitudinal axis A-A of the handle 32 may be adjusted. The relative positions between the between the adjustable arms 22, the handle 32, and the blade 16 provides a degree of stability and control that allows the operator to precisely and accurately control the cutting surface 20 of the blade 16 along curves, notches, and protrusions, including those involved in coping and sanding. In addition, this arrangement results in a compact design that positions the cutting surface 20 in close proximity to the handle 32.

Changes can be made in the above constructions without departing from the scope of the invention, it is intended that all matter contained in the above description or shown in the accompanying drawings shall be interpreted as illustrative and not in a limiting sense.

What is claimed is:

1. An attachment for a powered tool, comprising:
a frame including at least two spaced arms extending from an engagement end, wherein the engagement end is capable of removeable attachment with the powered tool;
at least two blade guides attached to the frame, wherein at least one blade guide is capable of engagement with the powered tool; and
a blade positioned in a coplanar relationship with the frame along the blade guides, the blade including a cutting surface extending between the arms of the frame.

2. The attachment of claim 1, further comprising:
a tension device attached to the frame and engaged with the blade for increasing and decreasing the tension on the blade.

3. The attachment of claim 2, wherein the tension device comprises:
tension rollers adjustably mounted to the frame;
an adjustment screw operatively connected to the tension rollers; and
an adjustment nut that is adjusted along the adjustment screw to increase and decrease the distance between the tension rollers and increase and decrease the tension of the blade.

4. The attachment of claim 1, wherein cutting surface of the blade is normal to the longitudinal axis of the frame.

5. The attachment of claim 1, further comprising:
bending rollers attached to the frame that rotate the angle of the cutting surface relative to the rest of the blade.

6. The attachment of claim 5, wherein the bending rollers rotate the cutting surface 90° relative to the rest of the blade.

7. The attachment of claim 1, further comprising:
material guides pivotally attached to the frame that pivot from an open to a closed position.

8. The attachment of claim 1, wherein the arms are adjustable in length so that the angle of the cutting surface relative to the longitudinal axis of the frame may be adjusted.

9. The attachment of claim 1, wherein the arms are pivotally attached to the frame so that the cutting surface may be rotated about the longitudinal axis of the handle.

10. An attachment for a powered tool comprising:
a frame including a pair of arms extending outwardly from an engagement end, the arms defining a open throat, the frame having a longitudinal axis;
at least two blade guides attached to the frame; and
a blade positioned in a coplanar relationship with the frame along the blade guides, the blade including a cutting surface extending between the arms of the frame along the throat and generally normal to the axis of the frame.

11. The attachment of claim 10, further comprising:
a tension device attached to the frame and engaged with the blade for increasing and decreasing the tension on the blade.

12. The attachment of claim 10, further comprising:
bending rollers attached to the frame that rotate the angle of the cutting surface relative to the rest of the blade.

13. The attachment of claim 10, further comprising:
material guides pivotally attached to the frame that pivot from an open to a closed position.

14. The attachment of claim 10, wherein the arms are adjustable in length so that the angle of the cutting surface relative to the longitudinal axis of the handle may be adjusted.

15. The attachment of claim 10, wherein the arms are pivotally attached to the handle so that the cutting surface may be rotated about the longitudinal axis of the frame.

16. An attachment for a powered tool, comprising:
a frame including at least two arms extending axially outwardly from an engagement end, the frame having a longitudinal axis;
at least two blade guides attached to the frame; and
a blade positioned along the blade guides, the blade including a cutting surface extending between the arms of the frame so that the cutting surface is normal to the longitudinal axis of the frame.

17. The attachment of claim 16, further comprising:
a tension device attached to the frame and engaged with the blade for increasing and decreasing the tension on the blade.

18. The attachment of claim 16, further comprising:
bending rollers attached to the frame that rotate the angle of the cutting surface relative to the rest of the blade.

19. The attachment of claim 16, further comprising:
material guides pivotally attached to the frame that pivot from an open to a closed position.

20. The attachment of claim 16, wherein the arms are adjustable in length so that the angle of the cutting surface relative to the longitudinal axis of the frame may be adjusted.

21. The attachment of claim 16, wherein the arms are pivotally attached to the engagement end so that the cutting surface may be rotated about the longitudinal axis of the handle.

22. The attachment of claim 16, wherein the frame is V-shaped.
